(19) United States
(12) Patent Application Publication
(10) Pub. No.: US 2006/0087497 A1
(43) Pub. Date: Apr. 27, 2006

(54) Digital pen for capturing hand-drawn data

(76) Inventors: Shekhar Ramachandra Borgaonkar, Bangalore (IN); Prasenjit Dey, Silchar (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/971,266

(22) Filed: Oct. 21, 2004

(51) Int. Cl. G09G 5/00

(52) U.S. Cl. 345/179

(57) ABSTRACT

A digital pen for capturing hand-drawn data on a medium is provided. The hand-drawn data is formed by moving the digital pen over the medium. The digital pen includes a color sensor and a processor. The color sensor detects color information of the medium when the pen is moved over the medium, and the processor determines the position of the digital pen based on the detected color information.

### FIELD OF THE INVENTION

The invention relates generally to a digital pen, and more particularly to a system and method for capturing hand-drawn data using a digital pen.

### BACKGROUND OF THE INVENTION

Writing and drawing are natural ways of jotting down notes. A person normally writes on a medium to keep track of appointments or tasks to complete. Drawing is also an effective means of illustration in a discussion. Post-it pads and notebooks are usually used as medium for writing or drawing for such purposes.

With the widespread use of computers, telecommunication devices and other electronic devices, documents are normally stored, transmitted and displayed in electronic form. In order to store, transmit and display the documents in electronic form, the written notes and drawings of the documents have to be scanned. This makes the converting of the documents into electronic form cumbersome and inconvenient.

To allow conversion of written notes and drawings directly into electronic form without scanning them, a digital pen can be used. The digital pen allows a person to write on a medium, such as paper, and capture what was written electronically. Many digital pens use a digital camera to scan or capture images of the written notes at regular intervals. The sequence of captured images can be processed using a processor to determine the strokes of the pen, and hence, the written notes.

The digital pen may be used in conjunction with a special paper to allow the position of the pen on the special paper to be determined. The special paper has a pattern which uniquely identifies the position on the paper. The digital pen captures an image of a portion of the special paper using the digital camera, and identifies its position on the paper based on the pattern in the captured image.

Another type of digital pen determines its position using an acoustic transmitter. Such a digital pen is used together with an acoustic receiver. The acoustic transmitter in the digital pen transmits an acoustic signal to the acoustic receiver when a user writes on the medium using the digital pen. Based on the acoustic signal received by the receiver, the position of the digital pen is determined.

It is desirable to provide a digital pen for capturing written data. The desired digital pen is preferably a low-cost standalone device that requires low processing power for determining its position compared to the digital pens described above.

### SUMMARY OF THE INVENTION

In an embodiment, a digital pen for capturing hand-drawn data on a medium is provided. The hand-drawn data is formed by moving the digital pen over the medium. The digital pen includes a color sensor and a processor. The color sensor detects color information of the medium when the pen is moved over the medium, and the processor determines the position of the digital pen based on the detected color information.

### BRIEF DESCRIPTION OF THE DRAWINGS

The embodiments of the invention will be better understood in view of the following drawings and the detailed description.

FIG. 1 shows a digital pen according to an embodiment of the invention.

FIG. 2 shows a color-coded medium according to an embodiment of the invention.

FIG. 3 shows the use of two colors having varying intensity as color information of a medium according to an embodiment of the invention.

FIG. 4 shows the use of a color having varying intensity and a series of lines as color information of a medium according to an embodiment of the invention.

FIG. 5 shows an example of a form having color-coded fields according to an embodiment of the invention.

FIG. 6 shows a block diagram for capturing hand-drawn data using the digital pen according to an embodiment of the invention.

### DETAILED DESCRIPTION OF THE INVENTION

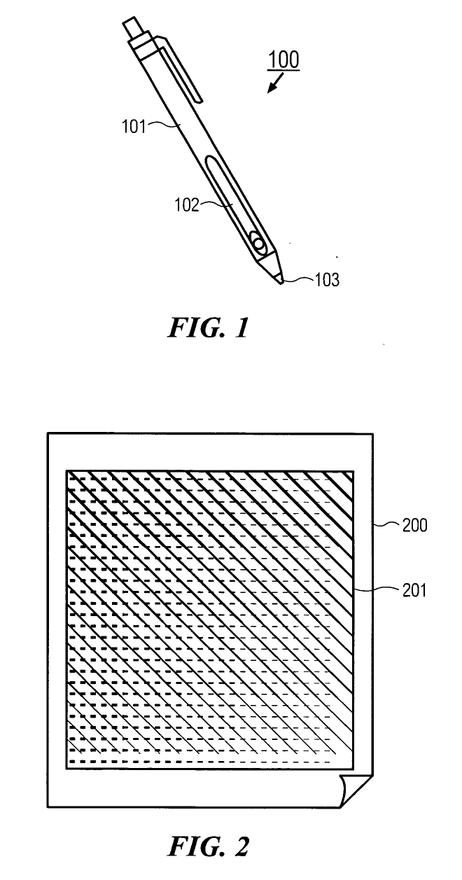

FIG. 1 shows a digital pen 100 according to an embodiment. The digital pen 100 includes a housing 101, a color sensor 102, an ink tip 103, a connection means (not shown) and a processor (not shown) arranged inside the housing 101.

A color sensor is a sensor which detects optical signals by contrast, true color or translucent index. True color sensors are based on one of the color models, such as Red-Blue-Green (RGB), Hue-Saturation-Brightness (HSB) and Cyan-Magenta-Yellow (CMY). The color sensor 102 according to the embodiment detects color information of a medium. In an embodiment, the color sensor 102 of the digital pen 100 is a RGB color sensor. Other types of color sensors may also be used in other embodiments. The color sensor 102 can be placed inside an optical housing (not shown) of the digital pen 100. The axis of the optical housing is parallel to the axis of the pen 100.

The processor is housed within the housing of the digital pen. The processor is adapted to process the color information detected by the color sensor 102, and to determine a position of the digital pen 100 corresponding to the detected color information. The processor may be implemented using a Digital Signal Processor (DSP) chip.

In another embodiment, the digital pen includes the ink tip 103 for forming marks or hand-drawn data on a medium. An ink forming element (not shown) housed inside the pen housing 101 normally supplies ink to the ink tip 103. Examples of an ink forming element includes but not limited to ink cartridges and any kind of ink refills for ball-point pens. The hand-drawn data is formed on the medium when a user writes or draws on the medium using the digital pen 100. As the user moves the pen 100 over the medium with the ink tip 103 contacting the medium, ink flows from the ink forming element through the ink tip 103 onto the medium. Accordingly, the hand-drawn data is formed. The hand-drawn data refers to any markings formed on the medium by the digital pen 100. Such markings include any kind of handwritings, scribbles and drawings.

The digital pen 100 includes a connection means (not shown) for transferring data from the digital pen 100 to another device such as a computer. The computer upon receiving the data may further process the received data and display the processed data, i.e. the captured hand-drawn data, on a display screen. In one embodiment, the connection means connects to the other device using a wireless connection such as radio frequency (RF) or Infrared. An example of a RF connection means is Bluetooth. In another embodiment, the connection means connects to the other device using a wired connection such as a serial port, a parallel port or a Universal Serial Bus (USB).

In an embodiment, the digital pen 100 is used in conjunction with a color-coded medium such as paper or any other medium which can be written on. An example of a color-coded medium 200 is shown in FIG. 2. The medium 200 includes printed color information 201. The color information 201 can be printed on the medium 200 using standard color printers, and normally includes one or more colors. Invisible colors such as ultra-violet and infrared may be used in other embodiments.

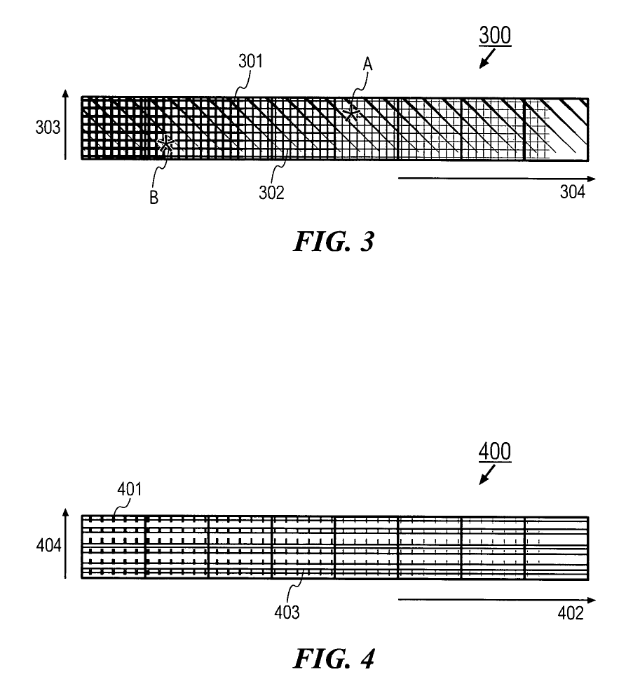

FIG. 3 shows the color information 300 using two colors according to an embodiment. The color information 300 includes a green portion 301 having intensity which varies in a vertical direction (y-axis) 303 and a yellow portion 302 having intensity which varies in a horizontal direction (x-axis) 304. The intensity of the green portion 301 decreases from the top to the bottom, and the intensity of the yellow portion 302 decreases from the left to the right. By measuring the intensity of the green portion 301 and the yellow portion 302, the (x,y) coordinates, and hence the position on the medium 200, can be determined. For example, position A has a higher intensity of green and a lower intensity of yellow compared to position B. It should be noted that it is possible to use any two colors for representing the color information 300 in other embodiments.

FIG. 4 shows the color information 400 using one color according to another embodiment. The color information 400 includes a purple portion 401 having intensity which varies in a horizontal direction 402 and a series of white lines 403 along a vertical direction 404. The intensity of the purple portion 401 decreases from the left to the right. The series of white lines 403 are spaced in a predefined manner such that a scanning of the series of lines 403 in a vertical direction 404 generates a series of pulses due to changes in the intensity of the purple portion 401. The pulses are spaced in a predefined manner. In this embodiment, the position along the horizontal direction is determined based on the intensity of the purple portion 401, and the position along the vertical direction 404 is determined based on the pulses produced by the changing intensity of the purple portion due to the series of white lines 403. It should also be noted that it is possible to use a different color for the color portion 401 and the series of lines 403 in other embodiments.

The digital pen 100 and the color-coded medium 200 can be used in a form filling application in an embodiment. In this embodiment, the color coded medium 200 is printed in a format of a form having various fields and spaces corresponding to each field for writing data. The form is filled up by a user using the digital pen 100 in the spaces provided. According to this embodiment, information written or entered on the form can be directly captured into electronic form without having to re-enter the information into a computer.

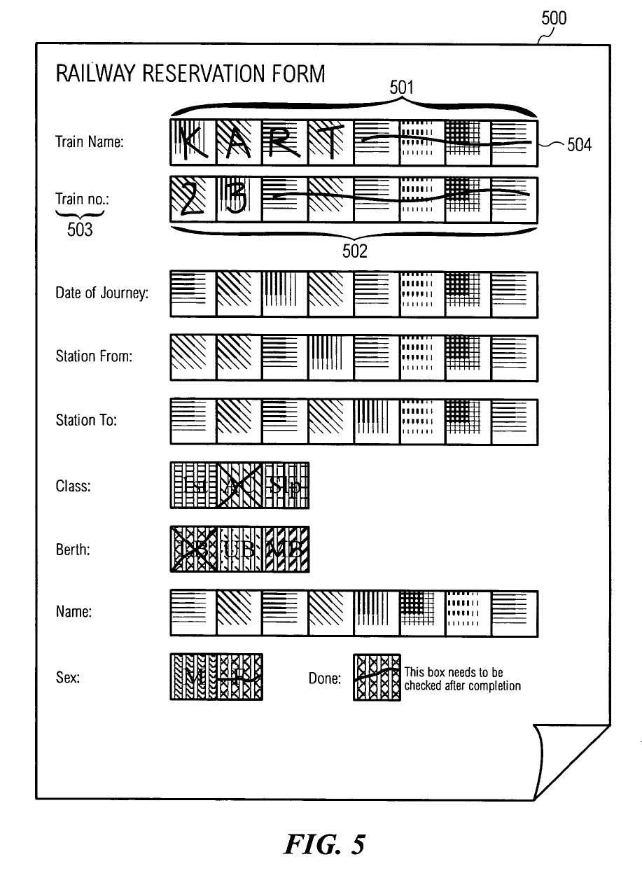

FIG. 5 shows an example of a form 500 which can be used in an embodiment. The form 500 includes fields 501 with corresponding spaces 502 for entering appropriate field data. The fields 501 are identified using Field Identities 503: Train name, Train no, Date of Journey, Station From, Station To, Class, Berth, Name, Sex and Done. The form 500 may also include Form Identity and Form Instance. The Form Identity identifies the form type (e.g. a Railway Reservation Form) and the Form Instance uniquely identifies the occurrence of the form type.

The spaces of each field for entering information include a series of blocks 504. Each block 504 includes one or more color of varying intensity. The Field Identities 503 Train name, Train no, Date of Journey, Station From, Station To and Name are identified by the sequence of colors of the blocks 502. The Field Identities 503 Class, Berth, Sex and Name are identified by a unique color combination. For example, the Field Identity Sex is identified by a color combination of blue and red for “M” and a color combination of green and yellow for “F”. The colors for the Field Identities 503 Class, Berth, Sex and Name are arranged as an alternating series of vertical bars. The Field Identity Done is used to signal the end of form filling. The color combination of the Field Identity Done may also be used to identify the Form Identity and Form Instance. The Field Identity Done may also be placed at the beginning of the form 500.

It should be noted that the form 500 as shown in FIG. 5 is an example of a possible form which can be used in an embodiment. It is also possible to use a different form having different form types and fields in other embodiments. The fields may be identified using the type of color information as shown in FIG. 3 instead of the sequence of color blocks 504. In this embodiment, each field is identified using a combination of two different colors. If N colors are available, the number of fields which can be identified by a combination of two colors is ^{N}C₂. For example, if 64 colors are available, the number of fields which can be identified is 2016.

In an embodiment, the fields are identified using the type of color information as shown in FIG. 4. When the color information types of FIG. 4 are used for a form, the number of fields which can be identified is equal to the number of colors available.

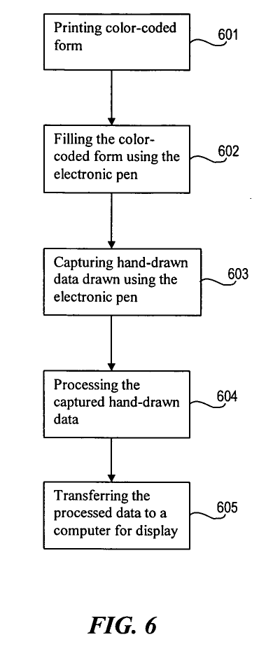

FIG. 6 shows a flow chart for capturing hand-drawn data using the digital pen 100 according to an embodiment. Step 601 includes printing the color information on a medium to form the color-coded medium 200. The color information may include color patterns as already illustrated in FIG. 3 and FIG. 4, or any other color patterns which allows a position on the medium 200 to be determined.

Step 602 includes writing or drawing on the color-coded medium 200 using the digital pen 100 as a normal pen. When the user writes or draws on the medium 200 using the electronic pen 100, ink is deposited onto the medium 200 to form the hand-drawn data. Step 602 can be illustrated with an example of a user filling up the form 500 of FIG. 5. The user fills up the form 500 of each field from the left to the right using the digital pen 100. Any unfilled boxes of each field are struck out. This allows the color sensor 102 of the digital pen 100 to scan the color (at step 603) of all the boxes of each field to determine the sequence of colors. For fields Class, Berth, and Sex, the user strikes out a box for each field. The box of the field Done is struck off by the user to signify that the filling the form 500 has been completed.

Step 603 includes scanning the color information of the medium 200 by the color sensor 102 of the digital pen 100 as the user writes or draws on the medium 200. The detected color information includes colors, intensity of each color, color intensity variations and sequence of colors detected, as already described above. The scanned or detected color information is processed by the processor of the digital pen 100 at step 604 to determine the position of the digital pen 100 on the medium 200.

Step 605 includes transferring the position data of the digital pen 100 to another device such as a computer or a personal digital assistant (PDA) using wired or wireless connection means. The position of the digital pen 100 and the corresponding time of the digital pen 100 represent the movement of the pen 100 or pen strokes. The pen strokes correspond to the hand-drawn data of the medium 200 formed using the digital pen 100. The position data is displayed on a display unit such as a screen of the computer or PDA as the captured hand-drawn data. The position data may be further processed before being displayed on the display unit.

The digital pen 100 described in the above embodiments is a standalone device which can write onto any paper having color information printed on it. The color information can be printed on the medium using any standard color printers. Specifically, the digital pen 100 need not be used together with any specific patterned paper or any other devices. The position data of the pen 100 is determined by the processor of the digital pen 100 based on color information. The processing of color information is lower in complexity compared to processing digital images captured using optical sensors (in particular digital cameras) of conventional digital pens. Accordingly, a low-end processor can be used in the digital pen 100.

Since the digital pen 100 according to the above embodiments is implemented using a low-end processor and a simple color sensor, the cost of the digital pen 100 is low when compared to conventional digital pens. In addition, the electronics for connecting the color sensor to the digital pen is simple, and hence, the cost of the digital pen is kept low.

Although the present invention has been described in accordance with the embodiments as shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A digital pen for capturing hand-drawn data on a medium, wherein the hand-drawn data is formed by moving the digital pen over the medium, the digital pen comprises:
a color sensor for detecting color information of the medium when the pen is moved over the medium; and
a processor for determining the position of the digital pen based on the detected color information.

2. The digital pen of claim 1, wherein the color sensor is a Red Green Blue (RGB) sensor.

3. The digital pen of claim 1, further comprises an ink forming element for forming the hand-drawn data when the digital pen is moved over the medium.

4. The digital pen of claim 1, further comprises a connection means for transferring data from the digital pen to another device.

5. The digital pen of claim 4, wherein the connection means comprises a Bluetooth connection.

6. The digital pen of claim 4, wherein the connection means comprises a Universal Serial Bus (USB) connection.

7. A hand-drawn data capturing system comprising:
a digital pen comprising:
a color sensor for detecting color information of the color-coded medium when the pen is moved over the color-coded medium; and
a processor for determining the position of the digital pen based on the detected color information, and
a color-coded medium,
wherein the hand-drawn data is formed by moving the digital pen over the color-coded medium.

8. The hand-drawn data capturing system of claim 7, wherein the color sensor is a Red Green Blue (RGB) sensor.

9. The hand-drawn data capturing system of claim 7, further comprises an ink forming element for forming the hand-drawn data when the digital pen is moved over the color-coded medium.

10. The hand-drawn data capturing system of claim 7, further comprises a connection means for transferring data from the digital pen to another device.

11. The hand-drawn data capturing system of claim 10, wherein the connection means comprises a Bluetooth connection.

12. The hand-drawn data capturing system of claim 10, wherein the connection means comprises a Universal Serial Bus (USB) connection.

13. The hand-drawn data capturing system of claim 7, wherein the color-coded medium is a paper having a plurality of colors printed thereon.

14. The hand-drawn data capturing system of claim 7, wherein the color information of the color-coded medium comprises color of varying intensity.

15. The hand-drawn data capturing system of claim 7, wherein the color information of the color-coded medium comprises a first color and a second color, wherein the intensity of the first color varies in a first direction and the intensity of the second color varies in a second direction.

16. The hand-drawn data capturing system of claim 7, wherein the color information of the color-coded medium comprises a first color of varying intensity in a first direction and a series of lines having a second color in a second direction.

17. A method of capturing hand-drawn data using a digital pen, the method comprising:
forming the hand-drawn data on a color-coded medium by moving the digital pen over the color-coded medium;
detecting color information of the color-coded medium when the digital pen is moved over the medium; and
determining the position of the digital pen based on the detected color information.

18. The method of claim 17, further comprising determining the movements of the digital pen based on the determined position of the digital pen, thereby capturing the hand-drawn data.

19. The method of claim 17, wherein detecting the color information of the color-coded medium comprises detecting the intensity of at least one color.
